(19) United States
(12) Patent Application Publication
(10) Pub. No.: US 2009/0147157 A1
(43) Pub. Date: Jun. 11, 2009

(54) DIGITAL PHOTO FRAME WITH A FUNCTION OF PROMPTING POWER OFF AND POWERING OFF AUTOMATICALLY

(75) Inventors: Ming-Feng Tsai, Tu-Cheng (TW); Xiao-Fang Chen, Shenzhen City (CN); Xiao-Guang Li, Shenzhen City (CN)

Correspondence Address: PCE INDUSTRY, INC.;ATT. Steven Reiss, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 12/261,013

(22) Filed: Oct. 29, 2008

(30) Foreign Application Priority Data
Dec. 5, 2007 (CN) 200710124817.X

(51) Int. Cl. H04N 5/64; G09G 5/00

(52) U.S. Cl. 348/836; 345/211; 348/E05.128

(57) ABSTRACT

A digital photo frame with a function of prompting power off and powering off automatically is provided. The digital photo frame includes a display unit, a power management unit, a storage unit, a power off prompt device, and a processing unit. The power off prompt device produces a prompting signal to remind user whether continue to enjoy the pictures. After finish displaying all the pictures, the processing unit controls the power off prompting device to produce the prompt signal to remind the user whether to continue enjoying the pictures. If the processing unit does not receive any input signals in a predetermined time period, the processing unit transmits a power off instruction to the power management unit, thus to control the power management to stop supplying power to the digital photo frame.

### BACKGROUND

1. Technical Field

The disclosure relates to electronic devices and, particularly, to digital photo frames.

2. General Background

Nowadays, digital photos are getting more and more popular while digital cameras are becoming more and more affordable. Accordingly, in order to display digital photos, digital photo frames are invented.

Like the traditional photo frames, many digital photo frames can be either placed on a table or mounted on a wall. The biggest advantage of digital photo frames have over traditional photo frames is that the digital photo frames are capable of storing a large number of pictures and displaying the pictures in a slide show mode. So, people around the DPF can enjoy a large number of pictures displayed by the DPF.

However, the disadvantage of the digital photo frames is their high power consumption. More often than not, even through no people around the DPF, the DPF remains at work state, which leads to unnecessary power waste.

Therefore, it is necessary to provide an digital photo frame to overcomes the above-identified deficiencies.

### SUMMARY

The present invention provides a digital photo frame with a function of prompting power off and powering off automatically.

The digital photo frame, includes: a power jack, a power management unit, an input unit, a storage unit, a processing unit and a power off prompt unit. The power jack is configured for connecting to a power supply. The power management unit is configured for distributing power from the power jack to the digital photo frame. The input unit is configured for generating signals in response to user's operations. The storage unit is configured for storing a plurality of digital pictures and display setting, the display setting includes choose which digital pictures to display.

The processing unit includes: a display setting obtaining module, a display controlling module, and an operation detection module. The display setting obtaining module is configured for obtaining the display setting from the storage unit, the display setting defines pictures which are desired to be displayed. The display controlling module is configured for displaying the desired digital pictures according to the display setting, and outputting a first instruction when displaying all the desired digital pictures. The operation detection module is configured for detecting whether the input unit generates input signals in a predetermined time period after receiving the first instruction, and outputting a power off instruction to control the power management unit to stop providing power to the digital photo frame if the input unit does not generates the input signals in the predetermined time period.

The power off prompt unit is configured for producing a prompt signal when receiving the first instruction.

### BRIEF DESCRIPTION OF THE DRAWINGS

The components in the drawings are not necessarily drawn to scale, the emphasis instead being placed upon clearly illustrating the principles of the digital photo frame. Moreover, in the drawings, like reference numerals designate corresponding parts throughout the several views.

FIG. 1 is a block diagram of a digital photo frame according to an exemplary embodiment.

FIG. 2 is a block diagram showing function modules of a processing unit of the digital photo frame of FIG. 1 according to an exemplary embodiment.

### DETAILED DESCRIPTION OF THE EMBODIMENTS

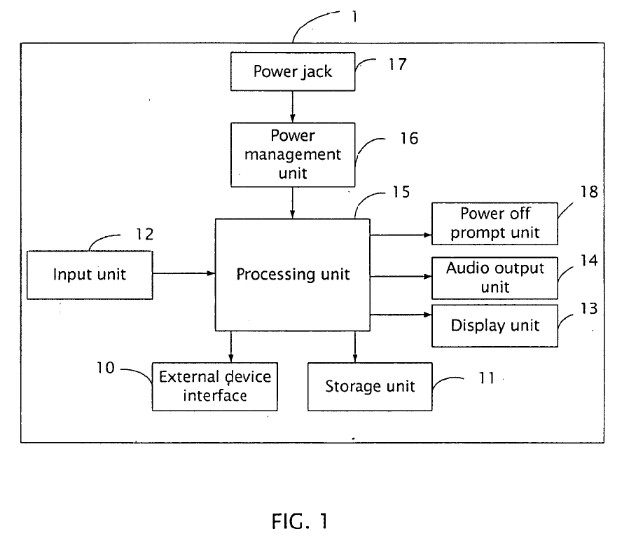

Referring to FIG. 1, the digital photo frame (DPF) 1 includes an external device interface 10, a storage unit 11, an input unit 12, a display unit 13, an audio output unit 14, a processing unit 15, a power management unit 16, a power jack 17, and a power off prompt unit 18.

The external device interface 10 is configured to connect with an external device (not shown). The external device can be a storage card (for example, a secure digital (SD) card, a compact flash (CF) card) or another electronic device (for example, a digital camera, a mobile phone or a computer).

The storage unit 11 is configured to store media files. The media files include, but is not limited to, audios, pictures, videos, etc. The storage unit 11 is a built-in storage unit, such as a flash memory, a micro drive, and so on. The input unit 12 is configured to generate input signals in response to user's operations. The input unit 12 can be an input key (button), a knob, and the like. The display unit 13 is configured to display the media files. The audio output unit 14 is configured to output audio signals.

The power jack 17 is configured to connect to a power source (not shown). The power source can be a battery, an alternating current to direct current (AC/DC) adaptor, and the like. The power management module 16 is configured to distribute power from the power source to a plurality of functional units of the DPF 1, such as the display unit 13, the audio output unit 14, and the processing unit 15.

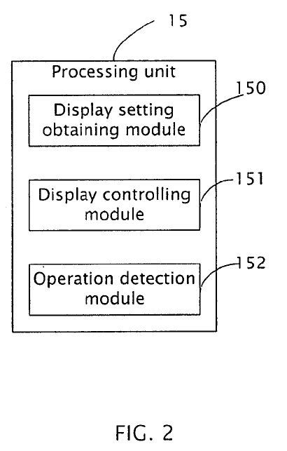

Referring also to FIG. 2, the processing unit 15 includes a display setting obtaining module 150, a display controlling module 151, and an operation detection module 152.

The display setting obtaining module 150 is configured to obtain a display setting of the DPF 1. The display setting can be set by a user through the input unit 12 and stored in the storage unit 11 after setting, or can be provided by the DPF 1 as system defaults. The display setting includes, but is not limited to, digital pictures desired to be displayed, a display interval of updating the digital pictures on the display unit 13, and a display mode. The display mode defines a transition effect where the digital pictures change from one slide to the next. For example, a transition such as out through black will indicate movement from one slide to the next. In the exemplary embodiment, the display mode includes, but is not limited to the out through black effect, push down effect and push left effect, etc. In the exemplary embodiment, the digital pictures are played according to the display interval and the display mode.

After the display setting obtaining module 150 obtains the display setting of the DPF 1, the display controlling module 151 obtains the desired digital pictures from the storage unit 11 and controls the desired digital pictures to be displayed according to the display interval and the display mode. For example, if the display interval is 5 seconds and the display mode defines the transition effect as push down effect, the display unit 13 updates the pictures thereon every 5 seconds and shows the push down effect. After displaying all the desired digital pictures, the display controlling module 151 produces a first instruction and transmits the first instruction to the power off prompt unit 18 and the operation detection module 152.

When the power off prompt unit 18 receives the first instruction, the power off prompt unit 18 produces a prompt signal to remind the people whether to continue displaying the digital pictures. The prompt signal can be presented in a predetermined form, such as a form of text, a form of image, a form of audio, a form of light, and the like. In the exemplary embodiment, the prompt signal is presented in the form of audio, that is, the prompt signal is an audio signal. When the power off prompt unit 18 receives the first instruction, the power off prompt unit 18 produces the audio signal and outputs the audio signal through the audio output unit 14.

When the operation detection module 152 receives the first instruction, the operation detection module 152 detects whether input signals from the input unit 12 are received in a predetermined time period. If the operation detection module 152 receives the input signals from the input unit 12 in the predetermined time period, that means, there is a person around the DPF 1, the operation detection module 152 produces a second instruction to control the power off prompt unit 18 to stop outputting the prompt signal. At the same time, the operation detection module 152 produces a repeat instruction and transmits the repeat instruction to the display controlling module 151. The display controlling module 151 controls the display unit 13 to display the digital pictures again when receiving the repeat instruction.

If the operation detection module 152 doesn't receive any input signals from the input unit 12 in the predetermined time period, that means there is nobody near the DPF 1 or there is nobody paying attention to the DPF 1, the operation detection module 152 transmits a power off instruction to the power management unit 16. The power management unit 16 stops providing the power from the power source to the functional units of the DPF 1 according to the power off instruction, thereby the DPF 1 is powered off.

As described above, the DPF 1 of the present invention is capable of outputting the prompt signal to prompt people whether to continue enjoying the digital pictures after the digital pictures have been displayed. If the DPF 1 receives input signals in the predetermined time period, that means people wants to enjoy the digital pictures, the DPF 1 continues displaying the digital pictures in response to the input. If the DPF 1 does not receive the input in the predetermined time period, that means nobody is around the DPF 1 or nobody wants to enjoy the digital pictures, the DPF 1 automatically powers off, thereby avoiding the power consumption.

It is believed that the present embodiments and their advantages will be understood from the foregoing description, and it will be apparent that various changes may be made thereto without departing from the spirit and scope of the invention or sacrificing all of its material advantages, the examples hereinbefore described merely being preferred or exemplary embodiments of the present invention.

What is claimed is:

1. A digital photo frame comprising:
a power jack configured for connecting to a power source;
a power management unit configured for distributing power from the power jack to the digital photo frame;
an input unit configured for generating signals in response to a user's operations;
a storage unit configured for storing a plurality of digital pictures and a display setting;
a processing unit comprising:
a display setting obtaining module configured for obtaining the display setting from the storage unit, wherein the display setting defines pictures which are desired to be displayed;
a display controlling module configured for displaying the desired digital pictures according to the display setting, and outputting a first instruction when all the desired digital pictures have been displayed; and
an operation detection module configured for detecting whether the input unit generates input signals in a predetermined time period after receiving the first instruction, and outputting a power off instruction to control the power management unit to stop providing power to the digital photo frame if the input unit does not generates the input signals in the predetermined time period; and
a power off prompt unit configured for producing a prompt signal and outputting the prompt signal when receiving the first instruction.

2. The digital photo frame of claim 1, wherein the operation detection module is further configured to transmit a second instruction to control the power off prompt module to stop outputting the prompt signal, and generate a repeat instruction to control the display controlling module to display the digital pictures again, if the input unit generates the input signals in the predetermined time period.

3. The digital photo frame of claim 1, wherein the display setting further defines a display interval of updating the digital pictures and a display mode of showing the digital pictures.

4. The digital photo frame of claim 3, wherein the display mode is selected from the group consisting of an out through black effect, a push down effect and a push left effect.

5. The digital photo frame of claimed 1, wherein the prompting signal is presented in a predetermined form, which is selected from the group consisting of a form of text, image, audio, and light.

6. A method of prompting power off and automatic powering off a digital photo frame, wherein the digital photo frame comprises:
an input unit;
a power management unit;
a detection unit;
a display setting obtaining module;
a display controlling module;
a operation detection module;
a power off prompt unit; and
a storage unit;
the method comprising the steps of:
obtaining display setting from the storage unit via the display setting obtaining module, wherein the display setting defines digital pictures which are desired to be displayed;
displaying the desired digital pictures according to the display setting under the controlling of the display controlling module;
producing a first instruction when the display controlling module detects all the desired digital pictures have been displayed;
outputting a prompt signal via the power off prompt unit when the power off prompt unit receives the first instruction from the display controlling module;
detecting whether the input unit generates input signals in a predetermined time period when the operation detection module receives the first instruction from the display controlling module; and
sending a power off instruction to control the power management unit to stop providing power to the digital photo frame when the operation detection module detects the input unit does not generates the input signals in the predetermined time period.

7. The method of claim 6, further comprising the steps of:
producing a second instruction when the operation detection module detects the input unit generates the input signals in the predetermined time period;
displaying the digital pictures again when the display controlling unit receives the second instruction from the operation detection module; and
stopping outputting the prompt signal when the power off prompt unit receives the second instruction from the operation detection module.
